(19) United States
(12) Patent Application Publication
(10) Pub. No.: US 2003/0126600 A1
(43) Pub. Date: Jul. 3, 2003

(54) Smart suggestions for upcoming TV programs

(75) Inventor: Jeroen Heuvelman, Campbell, CA (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 10/029,804

(22) Filed: Dec. 27, 2001

(51) Int. Cl. H04N 7/025; H04N 7/10

(52) U.S. Cl. 725/35; 725/32; 725/34

(57) ABSTRACT

A content recommendation system generates recommendations for new or upcoming content for a user while he/she may still consume a previous content. The system may take a wide variety of factors into account for determining the content recommendation and the moment rendering the recommendation whereby at least the progress of one of the previous and new content are taken into consideration.

### FIELD OF THE INVENTION

The invention relates to personalizing the presentation of content information, in particular, but not exclusively, TV broadcasts.

### BACKGROUND ART

Philips Electronics markets a Personal Video Recorder (PVR) that is powered by the TiVo service. The PVR allows a user to pause, rewind, slow-motion, and even frame-forward and back live TV. Fast forward with “Smart Scan” lets the user choose what to watch or skip. The PVR is compatible with direct broadcast satellite, cable and antenna. The PVR digital video recorder is connected between a TV set and cable box (digital or analog), satellite receiver, and/or antenna. Via the user's existing phone line, the recorder downloads up-to-date programming information from the TiVo service. The service further lets the user manage and create his/her own TV schedule with automatic digital recordings of favorite shows that are saved to a hard disk drive (HDD) without the user having to explicitly set a timer.

The PVR has several user-selectable operational modes listed as options in an on-screen menu. Choosing the option “now playing” brings up a graphical user interface that lists the programs previously recorded on the HDD. The user can select any of the programs for playing out. Choosing the option “watch live TV” lets the user watch any currently broadcast TV program.

### SUMMARY OF THE INVENTION

The PVR described above lets the user watch live TV programs or recorded programs according to the user selecting the operational mode and the available content information in that mode. For example, a live broadcast is selected from an electronic program guide (EPG) or by simply tuning to a specific channel via the remote's channel up/down keys. An EPG is an application in an interactive TV service that creates, based on data received from the service provider, an on-screen overview of all programs available. A recorded program is selected for play out by selecting the program from the list presented in the “now playing mode”. Accordingly, the user selects each time an individual program by interacting with the EPG or list of recorded items, or scans the channels until coming across a program to his/her current liking. That is, each time the user has to select an item of content information for play-out. The invention now, facilitates the selecting and at the same time increases the user-friendliness and level of user control regarding program selection.

The invention relates to a data management system for creating a personalized content information channel for an end-user. The system enables, e.g., to automatically play out a plurality of concatenated content information segments, or programs, selected on the basis of a criterion independent of a respective resource of respective ones of the programs. The concatenation enables a substantially continuous, or back-to-back, play-out as if the personalized channel were a conventional TV or radio channel. Respective resources comprise, for example, respective TV channels with live broadcasts. Preferably, the system comprises a recording device for time-shifting the play-out of at least a specific one of the programs so as to have it fit into the concatenation of the programs per personalized channel. The recording device can also be used as a resource for supply of a content information segment to the personalized channel. Multiple personalized content information channels can be created, each respective one thereof being associated with, e.g., a respective topic such as “movies”, “educational documentaries”, “sports”, “shows”, etc., or “westerns”, “musicals”, “movies featuring Katherine Hepburn”, “science fiction movies”, etc. Alternatively, or in addition, respective channels are created for respective members of the family so that everyone has his/her own personalized channel with content information according to his/her profile. As mentioned above, a resource may also comprise or provide recorded content information, e.g., as stored on a PVR or on a DVD in a DVD jukebox, on a CD or solid state memory, as a video-on-demand service, etc. Alternatively, a personalized channel comprises different types of programs or segments, as selected from the available resources. For example, a user has specified that his/her personalized channel on Saturday's be created as follows: first the news from CNN, then the weather forecast on the local weather channel, then a movie at PBS, and afterwards a late-night comedy show after a coffee break.

The system may only have to switch among live TV channels on occasion in order to create the personalized channel. However, in order to provide flexibility and user adaptability, recording for later play-out, and resources other than TV programs are included in the personal channel. The channel may not be limited to video only as a conventional TV channel, or audio only as a conventional radio channel, but may instead comprise content information of diverse formats for being played out via respective associated apparatus (display monitor, loudspeaker system, etc.).

Preferably, the system comprises a generator for generating an overview of the concatenated programs, preferably in a graphical user interface (GUI). Preferably, the overview allows some degree of user-interactivity, e.g., for letting the end-user control the compilation of the programs in the personalized channel, e.g., an order of playing-out the programs assigned to the concatenation or substituting another program for an earlier assigned one, etc.

An aspect of the invention relates to the creation of one or more virtual TV channels containing only programs which match predefined criteria, e.g., implicitly derived from a user's TV watching profile, explicitly defined by a user, etc. When multiple virtual TV channels are created, specific virtual channels can be assigned to family members, or a single person can create multiple virtual channels according to different kinds of content (based on topic, e.g., “my sports”, “my news”, “my movies”, etc.). Preferably, virtual channels can be locked, and it is possible to allow children to only watch the virtual channel(s) set up for them by their parents (virtual channels can also be made to ‘black out’ at times when the parents do not want their children to watch TV). Once set up, a user interacts with a virtual channel like he or she interacts with a conventional TV channel. When one program ends, the system automatically switches to the appropriate conventional channel or another resource for the next program in the virtual channel. Preferably, certain programs are stored in a buffer, e.g., a hard-disk drive (HDD)-based video recorder for time-shifted play-out, so as to reduce the occurrence of empty time slots or program overlap in a virtual channel. At any moment in time at most one program can be active for every virtual channel. There are many ways in which this program can be selected for a given virtual channel. For example, the user can explicitly select programs from all available conventional TV channels, e.g., through an EPG, for each or each desired, time slot in a virtual channel. Alternatively, or in combination with the user-selection, a virtual channel is automatically created based on a user's viewing profile by filling time slots with a matching or otherwise suitable program from all available conventional channels. For example, the user selects a program type for every time slot in a virtual channel, and based on a user's viewing profile a specific instance of that program type is automatically assigned to that time slot. As another example, the user explicitly selects programs for some of the time slots, and all other time slots are filled based on the user's viewing profile.

The expression “personalized content information channel” or “virtual channel” has been chosen to refer to the invention to indicate the continuous or substantially continuous back-to-back supply of content information as if it were a conventional TV or radio channel, wherein programs are concatenated in time by the broadcaster. The selection of programs for back-to-back supply in the system discussed above is under control of the individual end-user. Note that the programs in a conventional TV channel all comprise video content, and that all programs in a conventional radio channel comprise only audio. The invention allows to create a personalized channel on the home equipment across the media (audio, video, etc.) and the available resources (TV, radio, Internet, DVD, CD, HDD recorder, Video-on-Demand, etc.). For example, a personalized channel makes available on a specific day a live TV broadcast, a recorded TV broadcast, a DVD movie from the home network's DVD jukebox or player, a concert played from a CD on the home network, an audio program streamed via the Internet, etc.

An aspect of the invention resides in providing a service via a data network, e.g., the Internet. The service enables to create a personalized content information channel for an end-user, and comprises enabling to automatically play out a plurality of concatenated content information segments selected on the basis of one or more criteria independent of a respective resource of respective ones of the segments. Respective resources comprise, for example, respective TV channels, and the service supplies, for example, a personalized EPG and controls the switching between the proper channels or the proper channels and a recording device. The service controls the recording of at least a specific one of the segments for time-shifting the play-out so as to have it fit into a concatenation of the segments. The service may enable to create multiple personalized content information channels. The service may supply an overview of the concatenated segments scheduled for the personalized channel. The overview is, e.g., a personalized EPG or ECG (electronic content guide; see, e.g., U.S. Ser. No. 09/568,932 (attorney docket US 000106) filed May 11, 2000 for Eugene Shteyn and Rudy Roth for ELECTRONIC CONTENT GUIDE RENDERS CONTENT RESOURCES TRANSPARENT, referred to below and incorporated herein by reference). The overview preferably allows user-interactivity, e.g., for modifying the concatenation under user-control. In this way, the management of playing out and recording of the content information for this individual user is delegated to a server system. The server system may comprise a dedicated server to optimize the matching between content information and user profile. The server preferably has access to a profile of the user, to the user's home network for play-out and record control purposes, and to an inventory of content information (or parts thereof made accessible by explicit agreement from the user) for selecting pre-recorded local content. Note that a user database according to content information preferences is a valuable tool for commercial enterprises to offer products and services in targeted ads to the appropriate demographic groups.

Another aspect of the invention resides in a software application for being installed on a home network. The application controls the creating of a personalized content information channel for an end-user by enabling to automatically play out a plurality of concatenated content information segments that have been selected on the basis of a criterion independent of a respective resource of respective ones of the segments. EPGs and inventories of content information available locally, e.g., at the user's home entertainment equipment, enable the software application to select content segments under control of a user-profile and/or history of user-interaction with the equipment.

Yet a different aspect of the invention resides in a system that generates and presents a recommendation for information content, e.g., electronic information content, to a user. The recommendation comprises indications for one or more items for a second content while the user may still be consuming a first content. As an example, the user is watching a program on TV that is nearing its end. Nearing the end of the program the system will present to the user a recommendation for an upcoming show in which the user has shown an interest in the past. When the user likes the recommendation and accepts it, the system will switch to the upcoming show. Accepting the recommendation preferably is a user-friendly action, e.g., the user is not required to do anything. Preferably, the system is programmable, e.g., by the user, as to the manner of accepting or discarding the recommendation and processing the acceptance or discarding.

The system may take into account a variety of criteria in order to prepare the recommendation for the second content. These criteria include, e.g.,:

a user profile (e.g., the profile of the current individual user with regard to this user's preferences, viewing habits at a certain time or place, a demographic profile of a certain type of audience, etc.);

a recent history of content consumed (e.g., if the user just watched the news then it typically makes less sense to offer him/her similar news from another source); or

an explicit user request (the user may request the system to generate recommendations for him/her on, e.g., any baseball news or content available or only on new contemporarily comedy soap operas airings, etc., etc.).

The user may also be offered other options than to consume the content that is recommended. Such options include, e.g.,:

requesting additional information on the content; such information may include information as found in an EPG, from the Internet or by other means available information;

initiating a recording of the recommended content while, e.g., continuing consuming the current content or another content;

requesting another, possibly similar, recommendation or scrolling through a list of recommendations; or

requesting a pre- or post-processing on the recommended content, as example, by compiling a summary of a news program that is recommended or by deleting or replacing pre-inserted commercials upon viewing or recording.

When the user is considering a recommendation the system might offer the user a preview of any part of the recommended content by any audiovisual or other means. For example, the preview uses a PIP (picture-in-picture) presentation or sends graphical or text information to a touch screen remote control suitable for communicating wirelessly with CE or other equipment. The system might also offer information that is related to the recommended content. This might include offerings that include, e.g., E-commerce, VOD (Video-on-demand) or ppv/ppr (Pay-per-view/Pay-per-record) content or services.

The system may present the recommendation as comprising multiple of individual items or representations of the suggested next content. The items can typically be offered to the user in order of anticipated relevance in terms of urgency (e.g., for a content is available now or in the very near future), and/or importance (e.g., for a content that has high matching with previous described criteria). The presentation can be achieved by, e.g., one or combination of the following:

offering a list on a screen with a multiple of items of recommended content; one of the items could enable the user the option to select another list of recommendations; the list can be displayed on the screen in an obtrusive manner but also less obtrusive manners are envisioned (see further down for some examples);

by a ticker bar that scrolls on a side of a screen and that show typically only one item of recommended content at a time;

by showing only one or a limited number of items whereby the user is offered the option for showing more items of recommended content;

a recognition tune of a particular content being played out;

a voice that is presenting the recommendation;

a portable wireless device that can render the recommendation to the user, e.g., a wireless internet appliance, a remote control with touch screen or other graphical capabilities, PDA; etc.

The inventor also envisions a system whereby the user is notified in various ways of availability of a currently relevant recommendation for content by, e.g., an icon on the screen or a particular tune or sound. This notification can, for example, be displayed on the screen, whereby a video content is being consumed by the user, in an unobtrusive manner and may therefore hardly be regarded as being disturbing by the user. Examples of less obtrusive manners are:

a small symbol, e.g., a blinking icon in the corner of a TV-screen or remote control display;

a picture-in-picture window on, e.g., a TV-screen with information and or video;

audible signals such as a program recognition tune;

a ticker tape at the bottom of, e.g., a TV-screen; and

visible signals, e.g., a light, possibly flashing, elsewhere available in the system.

The user will typically be given the option to opt out for the system to generate the recommendation automatically. Instead, the user may be enabled to request explicitly for the recommendation and/or notification thereof. The user can, e.g., request for a recommendation notification upon availability of content that match certain criteria during watching the news but not during watching a baseball match.

In another embodiment the user can, e.g., view the recommendation by explicit means; for instance the user pushes a button to invoke a remote control command that activates display of the recommendation. Within this context, reference is made to universal programmable remote controls, such as the PRONTO™ of Philips Electronics, that allow the user to filly customize the configuration and IR/RF code set.

In yet another embodiment the user is enabled to have the recommendation displayed, or notification thereof, in an automated, yet user friendly, fashion, triggered by, e.g., one or more of the following events:

towards or at the end of a program currently being consumed for example during its credits;

during a commercial break of a program currently being consumed;

during a scene (of, e.g., of certain topic in a news program) from which it is known that the user has less interest in or dislikes or for which a parental guide blocking has been set;

at a scene change of a program currently being consumed (i.e., between two of its segments);

at an event or at the start of a scene of recommended content (e.g., of content that is expected to be of substantial relevance to the user);

at a substantially short time before a recommended content is to be received that is expected to be of substantial relevance to the user

upon activating, using or switching on the system or a recommendation rendering device;

upon usage by a newly identified user (the system should have means to identify a user, e.g., by a biometrics means integrated in a remote control or by voice detection means etc.);

during the watching of a program when another program is about to be available (or about to be airing) that matches the user preference even better then the current one.

An example of a user-relevant event that occurs, or is about to occur, is, e.g., during world soccer playout when several playoffs are airing simultaneously and when a goal has just been made during a playoff that the user is not watching. This can trigger the recommendation to be presented to the user. The invention works particularly well in a system that comprises a content pause buffer, e.g., a system that can present a recommendation while recording content that is being viewed by the user in a background buffer. In such a system the user is enabled to pause viewing the content while reviewing the recommendation and resuming viewing the content after the review. Especially, although not exclusively, in such a system cached AV/data (Audio, Video and/or Data) and/or even online AV/data can enrich the recommendation.

To enable some of the features of the system described earlier the system preferably should have knowledge on the progress on the content currently being consumed by the user and possible also on the progress on the recommended content. Data that might help to determine the progress of evolution of content (e.g., to which part of the content has the user advanced consuming it) may include, e.g., a start and stop time and a name or topic of a scene or music, start and stop time of a commercial break, start of the credits at the end of a program, time of the start of a highlight etc. Knowledge and (control-) data on the progress might be provided by:

a service that offers content progress date (this data can, e.g., originate from a director of the program or from the broadcasting station or from a dedicated service that provides this data, customized for each individual subscriber, for TV channels available in a geographic area, etc.);

screening content means (that analyses the content), e.g., a scene or scene change detector; preferably, multiple tuners and analyzing software are available at the end-user to scan and analyze the programs pre-selected as candidates on which to base the recommendations;

by analyzing available meta-data such as, but not limited to, an EPG (Electronic Program Guide) or Closed Caption information, chapter and scene information (similar or the same as that supplied with and embedded in a DVD-Video disk), etc.

Some or all of the recommendations can be prepared in advance, e.g., based on information from TV guides or from an EPG, possibly supplied in advance to the end-users if prepared by a party other than the user, and stored locally. The recommendations are then rendered at the proper time under control of a suitable trigger, either supplied from outside the user's environment, e.g., by the third party or supplied from a local source under control of software analyzing the EPG or the pre-selected candidates mentioned above incorporated herein by reference are the following patent documents:

U.S. Ser. No. 09/568,932 (attorney docket US 000106) filed May 11, 2000 for Eugene Shteyn and Rudy Roth for ELECTRONIC CONTENT GUIDE RENDERS CONTENT RESOURCES TRANSPARENT. This document relates to a data management system on a home network. The system collects data that is descriptive of content information available at various resources, including for example, an electronic program guide (EPG), on the network. The data is combined in a single menu to enable the user to select from the content, regardless of their resource.

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE. This document relates to facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

U.S. Ser. No. 09/802,618 (Attorney docket US 018028) filed Mar. 8, 2001 for Eugene Shteyn for ACTIVITY SCHEDULE CONTROLS PERSONALIZED ELECTRONIC CONTENT GUIDE. This document discloses a system and method wherein electronic content information and the time slots for play-out are being determined based on the activities scheduled in the user's electronic calendar and the user's profile or declared interests. In this manner, the recording and downloading of content is automated based on the user's life style. More specifically, an EPG and/or ECG is under control of the user's personal schedule, e.g., as represented on the user's electronic organizer with the user's scheduled personal activities. A data processing system is provided for managing electronic content information under control of data that is representative of at least one activity scheduled in a user's calendar. The system preferably has a control output for control of a data-recording device for recording the electronic content. The system also preferably has an input for receiving input data representative of an EPG, and an input for receipt of the data representative of the activity. The latter is then used for data communication between the system and an electronic calendar on, e.g., the user's PDA. The managing may comprise selecting specific content information based on a profile of the user. The profile comprises, for example, a preference regarding an attribute (e.g., genre, semantic content, performer, etc.) of the content information based on which the user ordinarily decides whether or not to watch or listen to it. The profile may also comprise relative priorities of the activities scheduled in the calendar with respect to each other and/or with respect to certain content information, or relative priorities of content information entities or files. The profile gives further criteria, in addition to the calendar, based on which the system processes, e.g., records or not, content information. The system preferably creates a GUI for presenting an overview of the specific content information available in the time slots other than those associated with the scheduled activities in the calendar. The system preferably dynamically adjusts the processing upon a user interaction with the calendar. For example, if the user enters a new activity into the calendar or cancels a scheduled one, the availability changes of the time slots that can be used for processing or playing out content information. Based on, e.g., the user's profile, the system may allocate new time slots to suitable content or time-shift the content to a new time slot fitting into the profile of the user.

U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE. This document relates to a method of enabling customizing a technical functionality of network- (e.g., Internet-) enabled equipment of an end-user. According to the method a profile of the end-user and information about a technical feature for use with the equipment are stored at a server system. Based on the user-profile it is determined whether or not the user should be notified about the availability of this feature. If it has been decided that there is a match between the user profile as stored and the information about this feature, the end-user gets notified via the network of the option to obtain the feature for being added to his/her equipment. In case the feature relates to new software, it can be downloaded via the network for preferably automatic installation in the equipment. In case the feature comprises a hardware component, it can be shipped to the end-user upon acceptance of the offer. A helpdesk is preferably provided through the network to help the end-user install the feature. This concept is based on the insight that network-enabled equipment will become a flexible repository into which the end-user can place new and exciting features over time dependent on the user's needs or desires, context of use, advancement of technology, etc. Not all end-users are always interested in all possible features for creating enhanced functionality of the equipment. Accordingly, a user-profile is established, either when the user registers his equipment with the notification service, or dynamically as a consequence of the user's interaction with the server system, or through a combination thereof. The profile is used to select technical features that are likely of interest to the user. In this manner, the user is kept abreast of the latest trends of interest to him/her. This service implicitly supports virtual recycling, as equipment needs to be designed for the purpose of being upgraded. The modular approach of adding or deleting technical software or hardware features as needed thus assists in slowing down the trend that products becoming obsolete fairly quickly, but without barring the manufacturer or aftermarket sales organizations from continuing doing business. This service is specifically relevant to vertical markets. A vertical market is a particular branch of commercial activity for which similar products or similar services are relevant. Examples of vertical markets are education, offices, hotels, consumers, hospitals, etc. Each of these segments has unique requirements for hardware devices and their functionality. Hardware manufacturers can make their devices more relevant to a specific vertical market segment by combining a relevant set of applications and services.

U.S. Ser. No. 09/653,784 (attorney docket US 000220) filed Sep. 1, 2000 for Frank Caris et al., for STB CONNECTS REMOTE TO WEB SITE FOR CUSTOMIZED CODE DOWNLOADS. This document relates to marketing a set top box (STB) together with a programmable remote. The remote has a dedicated button to connect the STB to a specific server on the Internet. The consumer can notify the server of his/her other CE equipment, which he/she desires to be controllable through the same remote as the one that came with the STB. The server downloads to the STB data representative of the relevant control codes. The STB is provided with means to program the remote with these codes. In return the server has obtained detailed and accurate information about this consumer's equipment. A reliable customer base can thus be built for streamlining Help Desk operations.

U.S. Ser. No. 09/823,658 (attorney docket US 018032) filed Mar. 29, 2001 for VIRTUAL PERSONALIZED TV CHANNEL for Jan van Ee. This document relates to a data management system that creates a personalized content information channel for an end-user by enabling to automatically play out a plurality of concatenated content information segments. These segments or programs have been selected on the basis of a criterion independent of a respective resource of respective ones of the segments.

### BRIEF DESCRIPTION OF THE DRAWING

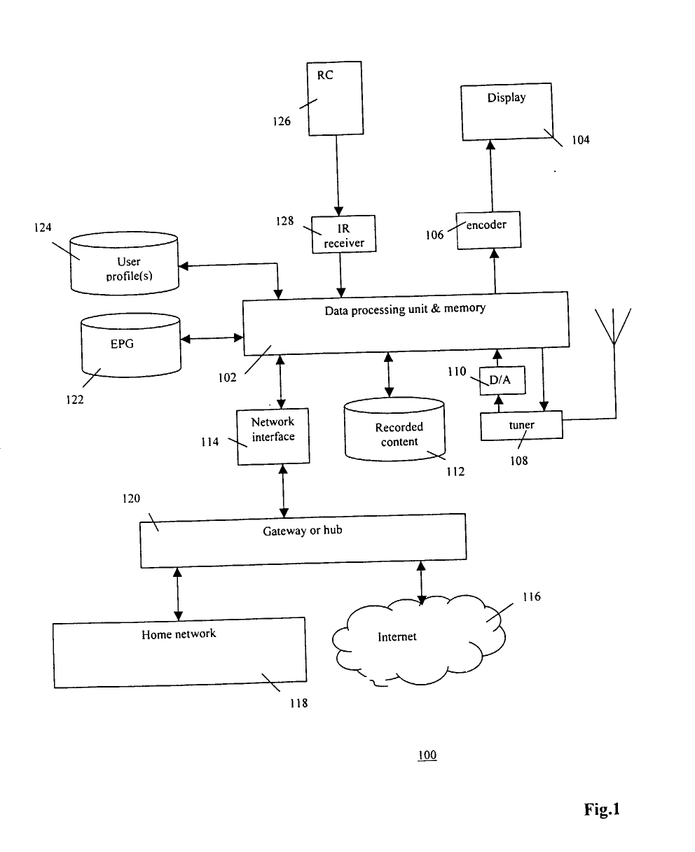

The invention is described in further detail, by way of example and with reference to the accompanying drawing, wherein FIG. 1, 2 and 3 are block diagrams of systems in the invention.

Throughout the drawing, same reference numerals indicate similar or corresponding features.

### DETAILED EMBODIMENT

FIG. 1 is a block diagram of a system 100 in the invention. System 100 comprises a data processing unit 102 with an onboard memory. System 100 further comprises a play-out apparatus 104, here a display monitor, coupled to unit 102 via an encoder 106; a TV tuner 108 whose content information output is coupled to unit 102 via a D/A converter 110, and whose control input is connected to unit 102 for controllably switching channels; a storage 112, e.g., a HDD, for storing digital content information; a network interface 114 for connecting unit 102 to the Internet 116 and to a home network 118 via a gateway or a hub 120; a storage 122 for storing a currently valid EPG; and a storage 124 for storing a user profile, e.g., in terms of the user's preferences with regard to genre's or types of content information or in terms of a history of user interaction with content offered via the EPG or available from other resources on home network 118, such as a DVD jukebox (not shown). The user interacts with system 100, e.g., via a remote control device 126 and an IR receiver 128 coupled to unit 102 for processing the IR commands.

In this example, the user profile represents the types of content information (e.g., audio, video) and time slots wherein the user wants to have the content information made available to him/her. The profile may also comprise indications of relative priorities this particular user assigns to certain programs. The priorities may be dependent on the time of the day or the day of the week, for example. Under control of the profile, and the available content information, system 100 creates a personalized channel for this user with content information segments, e.g., programs, played out back to back, or, in other words, without the user having to switch channels, or switch content providing resources. The back-to-back play-out can be interrupted automatically for a certain time period, e.g., if the user has specified this in advance in the profile or by a manual override through remote 126. Unit 102 selects content segments that match the user's profile based on the information available from EPG 122, from an inventory of recorded content 112 and based on information on the resources on home network 118.

EPG's are supplied by the service provider as data, and thus can be interpreted as to their semantic content and thus can serve as a basis for finding a match between the user's preferences and the available programs.

The recorded content information 112 comprises programs recorded on a previous occasion, e.g., under control of EPG 122. A recording control software application (not shown) running on unit 102 tags the content being recorded with the associated EPG data so as to enable semantic querying for the purposes of finding a match. Home network 118 comprises, for example, a DVD jukebox or a CD jukebox. Each DVD or CD has a unique identifier that enables to identify its content information, either through a service (not shown) on the Internet or by the data itself. In addition, the user may manually create a description of an inventory of his/her collection of content information on home network 118, e.g., via a PC, and make that available to unit 102. Accordingly, information about the content information available is present as data to enable a query that has been given as input a description of the user's profile.

Once system 100 has identified matching content for the time slots specified (if any), system 100 arranges broadcast programs, received via tuner 108 and played out in real time, recorded or time-shifted broadcast programs in storage 112, Internet TV (via a PC on home network 118) and a video-on-demand program (via a set top box on home network 118) in time and in a preferred order by control of the access to the programs' resources (tuner 108; storage 112; home network 118; Internet 116) and control of recording programs in storage 112.

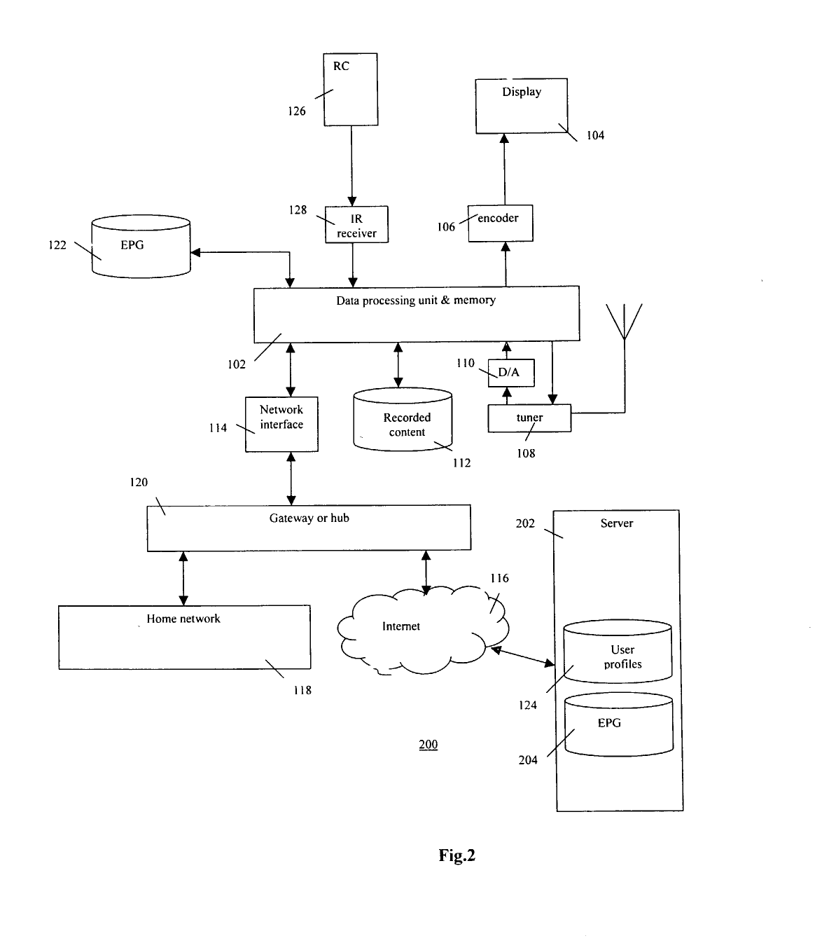

In above example of the invention, user profile storage 124 is part of the user's local equipment. FIG. 2 illustrates another example of a system 200 in the invention. In system 200, user profile 124 is stored at a remote server 202 that communicates with unit 102 via the Internet 116. Server 202 also has access to the EPG 204 to which service this user has subscribed. EPG 122 is the locally cached version of (a part of) EPG 204. Based on this, server 202 can find a match and send the recommended match as a control script to unit 102. This script controls tuner 108, the recording of programs in storage 112 and the playing out of recorded programs from storage 112. Preferably, server 202 has also access to an inventory of content information on home network 118, and to content providing services to which this user has access, e.g., via an STB or via the Internet. Based on this information, server 202 can optimize the matching of the content information with the user's profile and download the control script to unit 102 for control of tuner 108, control of storage 112, control of gateway 120 and control of home network 118. An advantage is that the processing power for running the queries and for generating the control scripts resides at a dedicated server instead of at the user's equipment. Moreover, the user can access his/her profile through the Internet from any connected PC or STB.

Server 202 thus obtains information about the profiles of this user and others who want to delegate the control at least partly to service provider 202. This customer base is highly valuable to third parties such as content providers, e.g., to optimize their services based on demographics, and on-line retailers, e.g., to provide targeted advertisements. Note that the supply of control scripts to enable creation of personalized content information channels is a business model that can be subsidized at least partly by advertisements that can be downloaded, e.g., from server 202 onto home network 118 or unit 102 and interspersed with, or overlaid on, the content information made available under control of the script.

Still other examples of an embodiment of the invention delegate the storage of content 112 to a remote server as well. The play-out time is known in advance and the download time of the remotely stored content is to be taken into account when preparing for play-out.

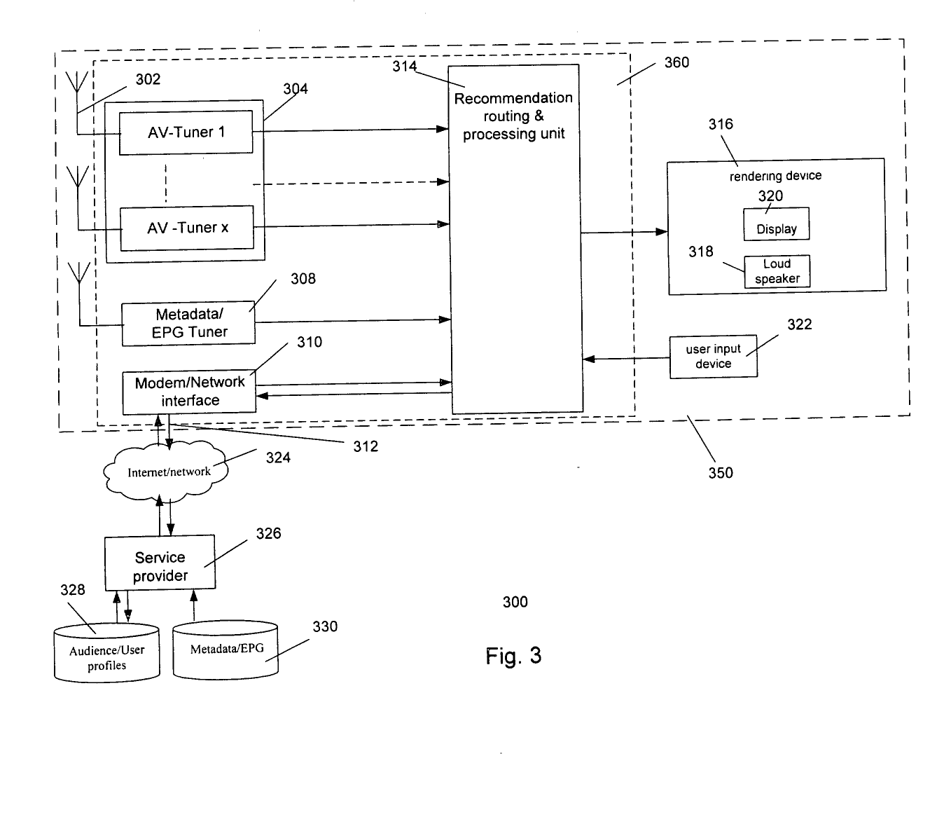

FIG. 3 is a block diagram of a system 300 in the invention. System 300 comprises:

home entertainment system 350;

antenna 302;

AV (Audio Video) tuner array 304;

meta-data tuner 308;

network interface 310;

network connection 312;

recommendation unit 314;

rendering device 316;

loudspeaker 318;

display monitor 320;

user input device 322;

internet 324;

service provider 326;

user profile database 328;

meta-data database 330; and

gateway device 360.

Examples of antenna 302 are a satellite dish anttena, a terrestrial antenna, a cable tuner connection and an in-home wireless network antenna. Antenna 302 is coupled to tuner array 304 that is coupled to recommendation unit 314. Tuner array 304 comprises one or more tuners for receiving any type of transmitted content or otherwise available content. As example, a broadcaster can transmit a TV channel that the tuner can receive and its content (programming) will become available at processing unit 214. Each tuner of array 304 can be tuned to a different channel that can receive different content. Meta-data tuner 308 receives data that typically provides electronic program guide information (EPG) or other types of meta-data on the received content of tuner array 304 plus meta-data on other content (e.g., on content of a channel to which none of the tuners of array 304 is currently tuned). Meta-data tuner 308, which is coupled to recommendation unit 314, can be of the same type of tuner of that of tuner array 304. Service provider 326 can provide recommendations preferably in real-time) to the user over internet-network 324 to the network interface 310 of home entertainment system 350. Network connection 312 is bi-directional in a preferred mode of operation although it can also be implemented as an input only to system 350. Although a bi-directional connection is not essential, it allows the system to send data on the user to service provider 326 that can in turn provide personalized data to system 350. Service provider 326 may provide content recommendations to system 350 and charge a fee from the user for this service. Service provider 326 may use data from various sources for compiling the recommendation. In system 300 database 328 and database 330 are examples of such sources. It should be noted that service provider may also use other sources of data such as data that is derived by screening the content itself such as data on a scene change, etc. Database 328 may comprise profiles on many users and may be updated on a regular basis by data of the user of the system 350 as well as other users. Database 330 may include data such as an electronic program guide, content markers and indices related to a particular piece of content, subtitling data (e.g., closed caption data) and content advisory data (e.g., violence chip data) etc. Recommendation unit 314 may also have means to screen content received from tuner array 304 in order to derive data that can be used for preparing a recommendation. Alternatively, service provider 326 may also provide this type of data or it may be explicitly embedded in the meta-data received from tuner 308.. Also by analyzing or interpreting meta-data provided by tuner 308 data may retrieved and used for compiling the recommendation. Tuner 308 is an optional part of system 300 and may be combined with a tuner from array 304. In an other alternative embodiment content is not provided to unit 314 by the tuner array but by other means, e.g., by service that delivers content over connection 312 to system 350. A recommendation may be output to rendering device 316 that presents the recommendation to the user by using display 320 or speaker 318. Typical examples of rendering device are a TV-set, a remote control with graphical capabilities etc. In a typical embodiment rendering device 316 is combined for rendering the content as well as the recommendation. The rendering of the content and the recommendation can also be done by separate rendering devices. For example the content can be rendered on a TV-set and the recommendation on a remote control with graphical or aural capabilities. The user can provide a feedback to processing unit 314 using user input device 322. Examples of device 322 are a remote control, a voice-recognizing device, a wireless internet appliance or a keyboard etc. It is clear for a person skilled in the art that processing unit 314 may be a very sophisticated device that may even be combined with array 304, tuner 308, and/or network interface 310 into a gateway device 360 such as a interactive set-top-box. This set-top-box may even include storage for content buffering, which may be beneficially used in combination with the recommendation unit. For instance a recommended program may be stored in a buffer, e.g., when it overlaps in time with a program that the user wants to watch, until the user is ready to watch it. Other compositions and partitionings of entertainment system 350 or parts thereof are possible as well. It is also envisioned that entertainment system is a lean device that merely passes content and recommendations to a user. An example of such a device is a wireless internet appliance that may include a network interface 324 for content as well as for recommendation input, a display 320 with a touch screen as user input device 322. In this example array 304 and tuner 308 and antenna 302 would not be necessary.

What is claimed is:

1. A method for making a recommendation for a second electronic content to a user, while the user is consuming a first electronic content, wherein the method comprises:
generating the recommendation for presenting the second content at a moment that depends on a progress of an evolution of at least the first or the second content.

2. The method of claim 1, wherein the recommendation further depends on data representative of at least one of:
a user profile;
an explicit user request; and
a recent history of consumed content.

3. The method of claim 1, wherein the second content information in the recommendation comprises multiple content items and wherein the items are offered to the user in order of relevance.

4. The method of claim 1, wherein the progress is determined by at least one of:
meta-data of at least the first or the second content; and
from screening of at least the first or the second content.

5. The method of claim 1, comprising enabling the user, upon presentation of the recommendation, to:
request additional information on the second content;
consume the second content upon availability;
initiate a recording of the second content; or
request another recommendation.

6. The method of claim 1, wherein the moment is chosen from at least one of the following:
in between two segments of the first content;
at or around the end of the first content;
a substantially short time before the second content is to become available; and
at or around a time of a trigger that is derived from the second content.

7. The method of claim 1, wherein the presenting comprises rendering the recommendation or a notification thereof using a portable wireless device.

8. The method of claim 1, the method further comprising:
generating an audible tune that is substantially representative of the second content.

9. The method of claim 8, further comprising:
enabling the user to accept the recommendation and to consume the second content.

10. A consumer system that enables to make a recommendation for a second electronic content to a user, while the user is consuming a first electronic content, wherein the system comprises means for providing the recommendation for the second content at a moment that depends on a progress of evolution of at least the first or the second content.

11. The system of claim 10, further comprising a first part for preparing the recommendation, wherein the first part comprises means for processing data representative of at least one of:
a user profile;
an explicit user request; and
a recent history of consuming content.

12. The system of claim 10, further comprising a second part for determining the progress that comprises at least one of:
means for screening content; and
means for processing meta-data representative of content.

13. The system of claim 10, further comprising a third part that enables the user, upon presentation of the recommendation, to:
request additional information on the second content;
consume the second content upon availability;
initiate a recording of the second content; or
request another recommendation.

14. The system of claim 10, further comprising a portable wireless device that can render the recommendation or notification thereof.

15. The system of claim 10, further comprising a fourth part for rendering the recommendation or a notification thereof that comprises at least one of:
a display comprising a picture in picture window capability;
a display comprising a ticker tape capability;
a generator for generating a graphical representation under control of the recommendation.

16. A recommendation for a second electronic content to a user, for being presented to the user while the user is consuming a first electronic content, and at a moment that depends on a progress of an evolution of at least the first or the second content.

17. An EPG comprising means for generating a recommendation for a second electronic content to a user, while the user is consuming a first electronic content, wherein the recommendation is presented to the user at a moment that depends on a progress of an evolution of at least the first or the second content.

18. A software application for controlling to make a recommendation for a second electronic content to a user, while the user is consuming a first electronic content, wherein the software comprises a first module for providing the recommendation for the second content at a moment that depends on a progress of evolution of at least the first or the second content.

19. A data service for generating a recommendation customized per subscriber for a second electronic content, the recommendation being rendered at the subscriber while the subscriber is consuming a first electronic content and at a moment that depends on a progress of evolution of at least the first or the second content.

20. The service of claim 19, using the Internet for supply of the recommendation.
